(19) United States
(12) Patent Application Publication
(10) Pub. No.: US 2019/0251586 A1
(43) Pub. Date: Aug. 15, 2019

(54) SYSTEMS AND METHODS OF PREDICTIVE MODELING FOR EVALUATING VEHICLES

(71) Applicant: Cox Automotive, Inc., Atlanta, GA (US)

(72) Inventors: Chris Stutsman, Austin, TX (US); Dale Pollak, Hinsdale, IL (US); Daniel Mitchell, Austin, TX (US); Thomas Cuthbertson, Austin, TX (US)

(73) Assignee: Cox Automotive, Inc., Atlanta, GA (US)

(21) Appl. No.: 16/270,991

(22) Filed: Feb. 8, 2019

Related U.S. Application Data
(60) Provisional application No. 62/628,519, filed on Feb. 9, 2018.

(51) Int. Cl. G06Q 30/02

(52) U.S. Cl. CPC G06Q 30/0206

(57) ABSTRACT

This disclosure describes systems, methods, and devices related to predictive modeling for evaluating vehicles. A device may receive vehicle information including a make, model, and year of a first vehicle. The device may determine a competitive set of vehicles that are of the same make, model, and year as the first vehicle, and that have with an odometer reading and a daily sale rate during a period of time. The device may determine, based on the odometer reading, an odometer-adjusted Cost to Market for the first vehicle. The device may determine, based on the daily sale rate during the period of time, a Market Day's Supply of the first vehicle. The device may determine, based on the Market Day's Supply and the odometer-adjusted Cost to Market, a vehicle score of the first vehicle. The device may send presentation data indicative of the vehicle score.

### CROSS-REFERENCE TO RELATED APPLICATIONS

This application claims the benefit of U.S. Provisional Application No. 62/628,519, filed Feb. 9, 2018, the disclosure of which is incorporated by reference as if set forth in full.

### TECHNICAL FIELD

This disclosure generally relates to systems and methods for modeling vehicle values and, more particularly, to using a cost-to-market estimate and a market day supply estimate to evaluate and recommend vehicles.

### BACKGROUND

Vehicle markets may be substantial. Used vehicle departments contribute significantly to dealership profitability when properly managed and are a primary source of financial liquidity. As a result, many vehicle dealerships consider used vehicle sales important for maintaining the ability to conduct vehicle sales transactions.

### BRIEF DESCRIPTION OF THE DRAWINGS

The detailed description is set forth with reference to the accompanying drawings, which are not necessarily drawn to scale. In the figures, the left-most digit(s) of a reference number identifies the figure in which the reference number first appears. The same reference numbers in different figures indicate similar or identical items.

FIG. 1 illustrates an example process for predictive modeling for evaluating vehicles, in accordance with one or more example embodiments of the present disclosure.

FIG. 2 depicts an illustrative system for predictive modeling for evaluating vehicles, in accordance with one or more example embodiments of the present disclosure.

FIG. 3 depicts an exemplary vehicle score matrix, in accordance with one or more example embodiments of the present disclosure.

FIG. 4 illustrates an example graphical output, in accordance with one or more example embodiments of the present disclosure.

FIG. 5 illustrates an example flow diagram showing a process for predictive modeling for evaluating vehicles, in accordance with one or more example embodiments of the present disclosure.

FIG. 6 illustrates a block diagram of an example of a machine, in accordance with one or more example embodiments of the present disclosure.

### DETAILED DESCRIPTION

Illustrative embodiments will now be described more fully hereinafter with reference to the accompanying drawings, in which some, but not all embodiments are shown. The disclosure may be embodied in many different forms and should not be construed as limited to the embodiments set forth herein; rather, these embodiments are provided so that this disclosure will satisfy applicable legal requirements. Like numbers refer to like elements throughout.

In vehicle sales, wholesale costs may continue to rise and retail prices may drop relative to the wholesale costs of vehicles, resulting in profit margin depression. Vehicle dealers may increase sale rates to account for decreased profit margins (e.g., a higher volume, lower profit margin model). The incentive to sell more vehicles may result in poor incentives, however. For example, to sell a vehicle more quickly, a dealer may reduce the cost of a vehicle when doing so may not make economic sense. In particular, some vehicles may be more valuable than other vehicles, and may sell at a higher price with a better profit margin if allowed to remain in inventory until being sold at the higher price rather than sold at a lower price in an effort to increase the pace and volume of vehicle sales.

Vehicle sellers often lack accurate real-time data for “like” vehicles and therefore may not be able to determine an accurate market value of a vehicle in real-time, as the aggregation of vehicle market data and the determining of updated vehicle values may be time consuming, and a vehicle dealer may need real-time values to make pricing and purchasing decisions. For example, the value of a 2016 pickup truck may be best compared to other 2016 pickup trucks of the same make, model, and year within a geographic area. The value of a 2016 pickup truck in San Francisco may not be the same as the value of the same 2016 make and model pickup truck in Dubuque. A vehicle seller in San Francisco may determine a vehicle value more accurately using similar vehicle data from San Francisco-area pickup trucks than using Dubuque-area pickup truck data.

Even with accurate attribute data, vehicle sellers may lack the ability to quickly determine the most accurate value of a vehicle using attribute data such make, model, year, location, features included in the vehicle, and other attributes. For example, vehicle sellers may lack the ability to adjust the prices of vehicles based on the odometer readings of similar, nearby vehicles. Vehicle sellers may lack the ability to adjust the value of a vehicle based on the supply of similar, nearby vehicles on a given day. Without accurate, relevant data for vehicle comparisons, vehicle sellers may adjust vehicle prices to sell vehicles at prices which do not reflect the market value of a vehicle in a seller's particular market at a given time. Vehicle sellers may not have time to aggregate and analyze relevant vehicle market information to determine the best value for a vehicle before or during a sale negotiation. Therefore, vehicle sellers may benefit from using enhanced predictive modeling of vehicles to receive vehicle value recommendations.

Vehicle sellers may not be able to manipulate vehicle inputs to find similar nearby vehicles and to provide updated inventory information while also being able to monitor the values of vehicles the sellers currently own without having to use multiple computer-based applications and application windows.

Example embodiments of the present disclosure relate to systems and methods for using a cost-to-market estimate and a market day supply estimate to evaluate and recommend vehicles.

Illustrative embodiments may generally be directed to, among other things, predicting the future success of a used vehicle in a dealer's inventory based on its likely profitability and time to sale. For example, a computer system may evaluate a used vehicle based on a correlation between a Market Day's Supply of the used vehicle and a Cost to Market of the used vehicle. The Cost to Market of a vehicle may refer to the cost of a seller to the expense of a vehicle which may allow for retail profit (e.g., a 90% Cost to Market may result in less profit margin than an 85% Cost to Market). The Market Day's Supply may refer to a measurement of supply and demand of a vehicle (e.g., a 60 day Market Day's Supply refers to vehicles selling more quickly than a 90 day Market Day's Supply).

A metric (e.g., “vehicle score”) may be derived from the relationship between the Market Day's Supply of the used vehicle and the Cost to Market of the used vehicle. The vehicle score may be an indicator of the future success of the used vehicle in the dealer's inventory based on the used vehicle's likely profitability and time to sale. In this manner, a vehicle dealer may make an informed decision on whether to buy the used vehicle, sell an existing used vehicle in inventory at a particular price, or hold onto a vehicle rather than dropping its sale price. The vehicle score may enable the dealer to determine the best used vehicles to purchase and the proper amount of money to invest, as well as provide the ability to evaluate current used vehicles in their inventory to better manage their existing inventory.

The vehicle score may be determined on a daily, weekly, or monthly basis. For example, the Market Day's Supply of the used vehicle and the Cost to Market of a particular vehicle may change daily. As a result, the vehicle score associated with the used vehicle may be automatically updated on a daily basis. In other instances, the vehicle score may be determined and/or updated in real time. The vehicle score also may be validated and/or updated in real time, daily, weekly, or monthly to ensure the vehicle score's accuracy. That is, the actual sale and profitability of vehicles that have been scored may be references in the vehicle score algorithm in order to confirm that the vehicle scores correspond to the actual potential future profitability of the vehicle.

In certain embodiments, the vehicle score may be derived from a vehicle score algorithm or matrix. In one exemplary embodiment, the vehicle score matrix may include the Market Day's Supply in the x-axis and the Cost to Market in the y-axis. The lower the Market Day's Supply and the Cost to Market, the better the vehicle score, for example. A good vehicle score means the vehicle is likely to be profitable to the dealer. In contrast, the higher the Market Day's Supply and the Cost to Market, the worse the vehicle score, for example. A bad vehicle score may translate to less profitability (e.g., possibly even a net loss). The vehicle score may be updated in real time, daily, weekly, or monthly. That is, the vehicle score in the matrix may be revised based on actual market conditions or other factors or algorithms.

The vehicle score may be used to evaluate a dealer's entire inventory of used vehicles. For example, the average vehicle score (or “inventory score”) associated with each of the used vehicles in the dealer's inventory may be determined. The dealer may use the inventory score to evaluate the status of its inventory. The inventory score may help the dealer determine which and how many vehicles to purchase or sell in order to maintain its ideal inventory score. In this manner, the dealer may make an informed decision on whether to buy one or more used vehicles and/or sell one or more existing used vehicles in inventory.

In certain embodiments, the value of a vehicle may be dependent on grouping similar vehicles into a competitive set of vehicles. A competitive set may refer to vehicles with the same make, model, year, and features (e.g., colors, sunroofs, extended cabs, four-wheel drive, number of engine cylinders, etc.). A computer system may aggregate vehicle data for similar vehicles in a given geographic area (e.g., a threshold radius/distance from the vehicle seller's location) and may generate a competitive set of vehicles for any particular make, model, and year vehicle. The computer system may query one or more databases for nearby vehicle data by inputting the make, model, year, and any features of a vehicle, and if the number of results (e.g., similar vehicles) found in a geographic area fails to meet a threshold number of vehicles, the computer system may add or remove vehicle features automatically or based on user inputs in order to generate a number of search results which exceeds a threshold value (e.g., a threshold may require that at least fifty similar vehicles in an area are included in a competitive set). The vehicle data in the databases used to provide query results to form the competitive set may be collected in real-time from one or more data providers, so the computer system's ability to determine a real-time competitive set for any make, model, and year vehicle in a geographic area may depend in another computer's ability to collect real-time data.

In certain embodiments, the computer system may determine the average list price and average odometer reading from the competitive set. For example, a vehicle with lower mileage may sell for a higher price than a vehicle with higher mileage. Odometer data of vehicles in the competitive set may indicate the mileage of each vehicle. When the computer system identifies similar vehicles to use in the competitive set, the computer system may receive data associated with the vehicles in addition to vehicle make, model, year, and location. The additional data may include vehicle odometer readings and current list prices. The computer system may determine the average list price of the vehicles in the competitive set, and may determine the average odometer reading of the vehicles in the competitive set.

In certain embodiments, the computer system may apply an odometer adjustment to the cost of the vehicles in a competitive set in order to normalize the average odometer reading of the competitive set. The odometer adjustment may refer to a price per mile adjustment (e.g., cents per mile), and the price per mile adjustment may vary based on the make, year, model, location, and/or other attributes of the vehicles in a competitive set. For example, a convertible sports car may have a different odometer adjustment than a minivan, and a newer version of a particular make and model vehicle may have a different odometer adjustment than an older version of the same vehicle. Therefore, the attributes used to query databases for similar vehicles to form a competitive set may affect the odometer adjustment applied to the competitive, so the computer system's ability to determine a competitive set of vehicles with common attributes may be important to the computer system's ability to determine the value of a vehicle at a given time.

In certain embodiments, the computer system may determine an odometer-adjusted Cost to Market for the vehicles in the competitive set. For example, the computer system may divide the odometer-adjusted cost of the vehicles in a competitive set by the average list price of the vehicles in the competitive set. The computer system may determine the odometer-adjusted Cost to Market for any vehicle in a competitive set by determining the average odometer reading of the vehicles in the competitive set by the average list price of the vehicles in the competitive set, and applying the value to any vehicle to determine a vehicle's respective odometer-adjusted Cost to Market value.

In certain embodiments, the computer system may determine a Market Day's Supply for vehicles in a competitive set. Using the returned vehicles in the competitive set, the computer system may count the number of currently available vehicles in the market and divide the number of currently available vehicles by a daily sale rate of similar cars (e.g., same make, model, year, etc.) over an interval of time (e.g., 45 days) to determine the Market Day's Supply for a vehicle. The interval of time may be set to a value long enough to account for significant daily sale changes (e.g., day with an unusually high number of sales of the type of vehicle in a competitive set). For example, if many vehicles in a competitive set sell on a particular day, the Market Day's Supply may be affected by a high daily sale rate. If the next day were a normal sale day (e.g., with lower sales of vehicles from the competitive set than the high-selling day), the Market Day's Supply would not necessarily fluctuate a significant amount, leading to a significant fluctuation in vehicle value from day-to-day. The interval of time may account for such fluctuations by considering the daily sale rate of vehicles in the competitive set over multiple days or weeks.

In certain embodiments, the Market Day's Supply may be calculated by dividing the current market quantity of a used vehicle of the same or similar year, make, model, trim level, etc., by the average daily retail sales rate over a period of time (e.g., the past 45 days). For example, if there are 10 identical or similarly equipped used vehicles for sale in the market and over the past 45 days they have been selling at 1 per day retail, then the Market Day's Supply is determined by dividing 10 by 1 to derive a 10 Market Day's Supply of that vehicle. The Market Day's Supply may indicate the demand of a vehicle on a given day. A higher Market Day's Supply may be indicative of a vehicle taking longer time to sell than a vehicle with a smaller Market Day's Supply.

In certain embodiments, the computer system may determine a confidence score for any vehicle in a competitive set of vehicles. The computer system may determine a standard deviation of the prices of the vehicles in the competitive set as a percentage of the average list price of the vehicles in the competitive set. A vehicle's confidence score may be the vehicle's standard deviation of the average list price of the vehicles in the competitive set. The confidence score of a vehicle may refer to a statistical confidence in the market price of the vehicle. For example, the confidence score may represent the standard deviation of the price of the vehicle from the average vehicle price among the vehicles in the competitive set as a percentage of the average vehicle price of the vehicles in the competitive set. The confidence score for a competitive set if the standard deviation of the prices of the vehicles in the competitive set is lower.

In certain embodiments, the computer system may determine a quality score for any vehicle in a competitive set. Cheaper vehicles may need a lower Cost to Market score compared to a more expensive vehicle, for example, as a higher Cost to Market for a vehicle with a lower price may result in a lower profit margin. A more expensive vehicle may make a higher profit for a seller even with a higher Cost to Market. Therefore, the computer system may assign a score within a score range (e.g., from 1 to 11) based on the Cost to Market and the Market Day's Supply for any vehicle. The computer system may adjust the quality score to account for the confidence score of a vehicle. A higher confidence score may cause the computer system to determine a higher quality score, and a lower confidence score may cause the computer system to determine a lower quality score. The computer system may assign a higher quality score to a vehicle based on the Cost to Market and the Market Day's Supply. For example, a vehicle with a lower Market Day's supply (e.g., a fast-selling vehicle) and a lower Cost to Market may receive a higher quality score because the vehicle may sell quickly at a higher profit margin than a vehicle which may take more time to sell at a lower profit margin. If a daily sale rate of a vehicle is greater than 1 or another threshold value, the computer system may increase the quality score (e.g., may increment the quality score by 1 or another value).

In certain embodiments, the computer system may use the quality score of a vehicle to make recommendations to a user. For example, a high quality score may represent a strong investment, and the computer system may recommend that vehicle sellers wait to sell vehicles which are strong investments. A lower quality score may represent a poor investment, and the computer system may recommend that a vehicle seller price vehicles which are poor investments at lower prices to sell the lower-quality investment vehicles more quickly. The computer system may rank competitive sets of vehicles based on their quality scores. Vehicles and their respective quality scores may be presented using one or more graphical user interfaces. The computer system may use the one or more graphical user interfaces to display vehicle data, including the makes, models, and years of vehicles and any of vehicle features/attributes, and the computer system may output recommendations such as to increase or decrease price, hold onto a vehicle, move a vehicle quickly, etc. The real-time nature of the computer system's outputs may provide vehicle sellers with updated data to make quick, informed decisions regarding whether to change vehicle prices, negotiate vehicle prices, buy, or sell vehicles. The computer system may overlay recommendations with any vehicle information to allow a user to view whether a vehicle is priced competitively or should be adjusted in price while also presenting useful information regarding other vehicles in inventory and/or in a geographic area.

It may be desirable for vehicle sellers to maintain a balance between vehicles of higher and lower value. For example, if a vehicle seller has too many vehicles which may sell quickly, the seller may need to quickly replace vehicles in inventory to have more vehicles to sell. The vehicle seller may want to keep a number of vehicles with high enough value that the vehicles may eventually sell at higher profit margins over time, and may want to sell other vehicles quickly because those vehicles may not produce significant profit margins over time. The computer system may recommend waiting and/or adjusting prices according to an appropriate balance as determined by user inputs and/or determined automatically by the computer system. For example, the computer system may provide recommendations based on optimal parameters regarding revenue and profit margins over a period of time, the number of vehicles which may be kept at a particular location, and other factors. The computer system may make recommendations based on user inputs and/or machine learning in which the computer system may train itself over time to identify the optimal Market Day's Supply, sale rates, and the like.

In certain embodiments, the Cost to Market may be calculated by dividing the cost of the used vehicle by the average list price of the same or similar vehicles. For example, the Cost to Market may measure the “spread” between the amount a dealer pays to acquire and recondition a used vehicle and the average retail price for the same/similar vehicles available in a market.

In certain embodiments, the systems and methods described herein may be executed on a vehicle score platform. The vehicle score platform may operate on one or more servers. The vehicle score platform may be accessible over a network via a dealer computing device. A dealer may enter vehicle information via the dealer computing device into the vehicle score platform. The vehicle information may include at least a portion of a vehicle identification number (VIN), a make, a model, a year, a condition, a color, a trim, a mileage, etc. The vehicle information also may include an acquisition cost of the dealer to purchase the used vehicle. The vehicle score platform uses the vehicle information to calculate the vehicle quality score. In some instances, the vehicle quality score may be binary. That is, the vehicle score may simply be a “yes” or “no” regarding the purpose of the vehicle (e.g., keep the vehicle, sell the vehicle, etc.). In other instances, the vehicle quality score may be a range.

In certain embodiments, the items scored through the platform may be any products or services that may be sold or exchanged including, for example, and without limitation, vehicles, vehicle parts, computer products, firearms, articles of clothing, gemstones, jewelry, consumer electronics, electronics parts, yard appliances, construction machines and equipment, aircraft, boats, office equipment, furniture, manufacturing equipment, packaging equipment, kitchen equipment, appliances, raw materials, mineral rights, water rights, combinations of the foregoing, or the like, or related products and components. While some of the embodiments of this detailed description are described in terms of used vehicles, those of skill in the art will understand that the disclosure is not so limited, and other products, as described herein, could be substituted for vehicles.

This brief introduction, including section titles and corresponding summaries, is provided for convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

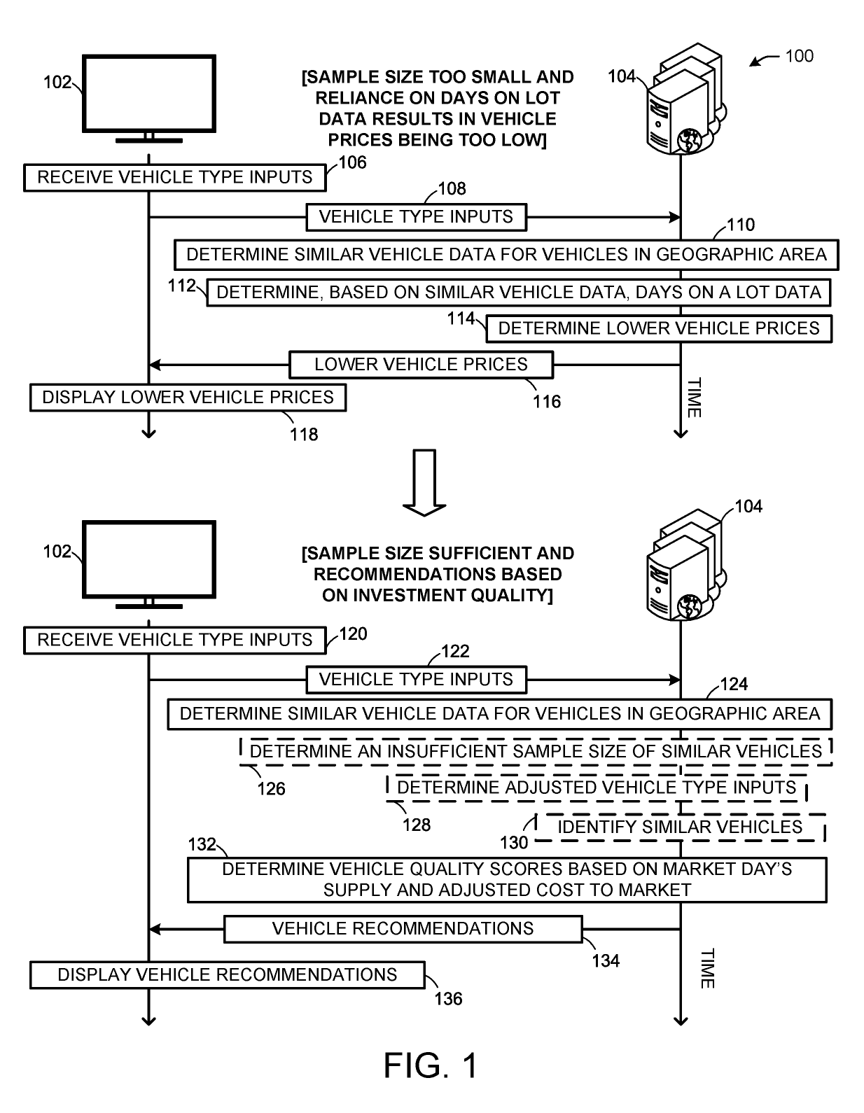

FIG. 1 illustrates an example process 100 for predictive modeling for evaluating vehicles, in accordance with one or more example embodiments of the present disclosure.

Referring to FIG. 1, a device 102 may communicate with one or more servers 104. The device 102 may receive vehicle type inputs at step 106 (e.g., a vehicle make, model, and year, and additional features of a vehicle). The device 102 may, at step 108, send the vehicle type inputs to the one or more servers 104. The one or more servers 104 may use the vehicle type inputs to determine similar vehicle data for vehicles in a geographic area at step 110. For example, the one or more servers 104 may identify vehicles within a radius distance and having the same make, model, year, and other features as provided in the vehicle type inputs. At step 112, the one or more servers 104 may determine, using the similar vehicle data, days on lot data. For example, the one or more servers 104 may determine the number of days that similar vehicles have been on respective lots. At step 114, the one or more servers 104 may determine lower prices at which to sell the similar vehicles in order to account for a high number of days of the similar vehicles being on respective lots. At step 116, the one or more servers 104 may send the lower vehicle prices to the device 102 for display. At step 118, the device 102 may display the lower vehicle prices. The lower prices may be determined by the one or more servers 104 to prevent vehicles from being on a lot for too long. However, reducing vehicle prices based on days on lot may lead to reduced profit margins when the value of a vehicle may warrant a higher price.

Still referring to FIG. 1, at step 120 the device 102 may receive vehicle type inputs (e.g., a vehicle make, model, and year, and additional features of a vehicle). The device 102 may, at step 122, send the vehicle type inputs to the one or more servers 104. The one or more servers 104 may use the vehicle type inputs to determine similar vehicle data for vehicles in a geographic area at step 124. For example, the one or more servers 104 may identify vehicles within a radius distance and having the same make, model, year, and other features as provided in the vehicle type inputs. The one or more servers 104 may determine whether the number of similar vehicles matching the vehicle type inputs in a given geographic area exceeds a threshold number of vehicles. If not, the one or more servers may determine, at step 126, and insufficient sample size of similar vehicles to use in a competitive set of vehicles. If the number of vehicles does not provide a sufficient sample size, the one or more servers 104 may prompt the device 102 for different vehicle type inputs, and may receive the adjusted vehicle type inputs or may automatically determine adjusted vehicle type inputs at step 128. Using the adjusted vehicle type inputs, at step 130, the one or more servers 104 may identify similar vehicles to use in the competitive set of vehicles. At step 132, the one or more servers 104 may determine vehicle quality scores based on a Market Day's Supply and a Cost to Market of the vehicles in the competitive set. Based on the vehicle quality scores of the competitive set and any other competitive set determined based on other vehicle type inputs, the one or more servers 104 may send vehicle recommendations to the device 102 at step 134. At step 136, the device 102 may display the vehicle recommendations.

In certain embodiments, the vehicle score may be derived from a vehicle score algorithm or matrix. In one exemplary embodiment, the vehicle score matrix may include the Market Day's Supply in the x-axis and the Cost to Market in the y-axis. The lower the Market Day's Supply and the Cost to Market, the better the vehicle score, for example. A good vehicle score means the vehicle is likely to be profitable to the dealer. In contrast, the higher the Market Day's Supply and the Cost to Market, the worse the vehicle score, for example. A bad vehicle score may translate to less profitability (e.g., possibly even a net loss). The vehicle score may be updated in real time, daily, weekly, or monthly. That is, the vehicle score in the matrix may be revised based on actual market conditions or other factors or algorithms.

In certain embodiments, the one or more servers 104 may aggregate vehicle data for similar vehicles in a given geographic area (e.g., a threshold radius/distance from the vehicle seller's location, which may be provided by an input from the device 102 or determined by the one or more servers 104) and may generate a competitive set of vehicles for any particular make, model, and year vehicle.

In certain embodiments, the one or more servers 104 may determine the average list price and average odometer reading from the competitive set. For example, a vehicle with lower mileage may sell for a higher price than a vehicle with higher mileage. Odometer data of vehicles in the competitive set may indicate the mileage of each vehicle. When the one or more servers 104 identifies similar vehicles to use in the competitive set, the one or more servers 104 may receive data associated with the vehicles in addition to vehicle make, model, year, and location. The additional data may include vehicle odometer readings and current list prices. The one or more servers 104 may determine the average list price of the vehicles in the competitive set, and may determine the average odometer reading of the vehicles in the competitive set.

In certain embodiments, the one or more servers 104 may apply an odometer adjustment to the cost of the vehicles in a competitive set in order to normalize the average odometer reading of the competitive set. The odometer adjustment may refer to a price per mile adjustment (e.g., cents per mile), and the price per mile adjustment may vary based on the make, year, model, location, and/or other attributes of the vehicles in a competitive set.

In certain embodiments, the one or more servers 104 may determine an odometer-adjusted Cost to Market for the vehicles in the competitive set. For example, the one or more servers 104 may divide the odometer-adjusted cost of the vehicles in a competitive set by the average list price of the vehicles in the competitive set. The one or more servers 104 may determine the odometer-adjusted Cost to Market for any vehicle in a competitive set by determining the average odometer reading of the vehicles in the competitive set by the average list price of the vehicles in the competitive set, and applying the value to any vehicle to determine a vehicle's respective odometer-adjusted Cost to Market value.

In certain embodiments, the one or more servers 104 may determine a Market Day's Supply for vehicles in a competitive set. Using the returned vehicles in the competitive set, the computer system may count the number of currently available vehicles in the market and divide the number of currently available vehicles by a daily sale rate of similar cars (e.g., same make, model, year, etc.) over an interval of time (e.g., 45 days) to determine the Market Day's Supply for a vehicle.

In certain embodiments, the Market Day's Supply may be calculated by dividing the current market quantity of a used vehicle of the same or similar year, make, model, trim level, etc., by the average daily retail sales rate over a period of time (e.g., the past 45 days).

In certain embodiments, the one or more servers 104 may determine a confidence score for any vehicle in a competitive set of vehicles. The one or more servers 104 may determine a standard deviation of the prices of the vehicles in the competitive set as a percentage of the average list price of the vehicles in the competitive set.

In certain embodiments, the one or more servers 104 may determine a quality score for any vehicle in a competitive set. Cheaper vehicles may need a lower Cost to Market score compared to a more expensive vehicle, for example, as a higher Cost to Market for a vehicle with a lower price may result in a lower profit margin. A more expensive vehicle may make a higher profit for a seller even with a higher Cost to Market. Therefore, the one or more servers 104 may assign a score within a score range (e.g., from 1 to 11) based on the Cost to Market and the Market Day's Supply for any vehicle. The one or more servers 104 may adjust the quality score to account for the confidence score of a vehicle. A higher confidence score may cause the one or more servers 104 to determine a higher quality score, and a lower confidence score may cause the one or more servers 104 to determine a lower quality score. The one or more servers 104 may assign a higher quality score to a vehicle based on the Cost to Market and the Market Day's Supply. If a daily sale rate of a vehicle is greater than 1 or another threshold value, the one or more servers 104 may increase the quality score (e.g., may increment the quality score by 1 or another value).

In certain embodiments, the one or more servers 104 may use the quality score of a vehicle to make recommendations to a user. For example, a high quality score may represent a strong investment, and the one or more servers 104 may recommend that vehicle sellers wait to sell vehicles which are strong investments. A lower quality score may represent a poor investment, and the one or more servers 104 may recommend that a vehicle seller price vehicles which are poor investments at lower prices to sell the lower-quality investment vehicles more quickly.

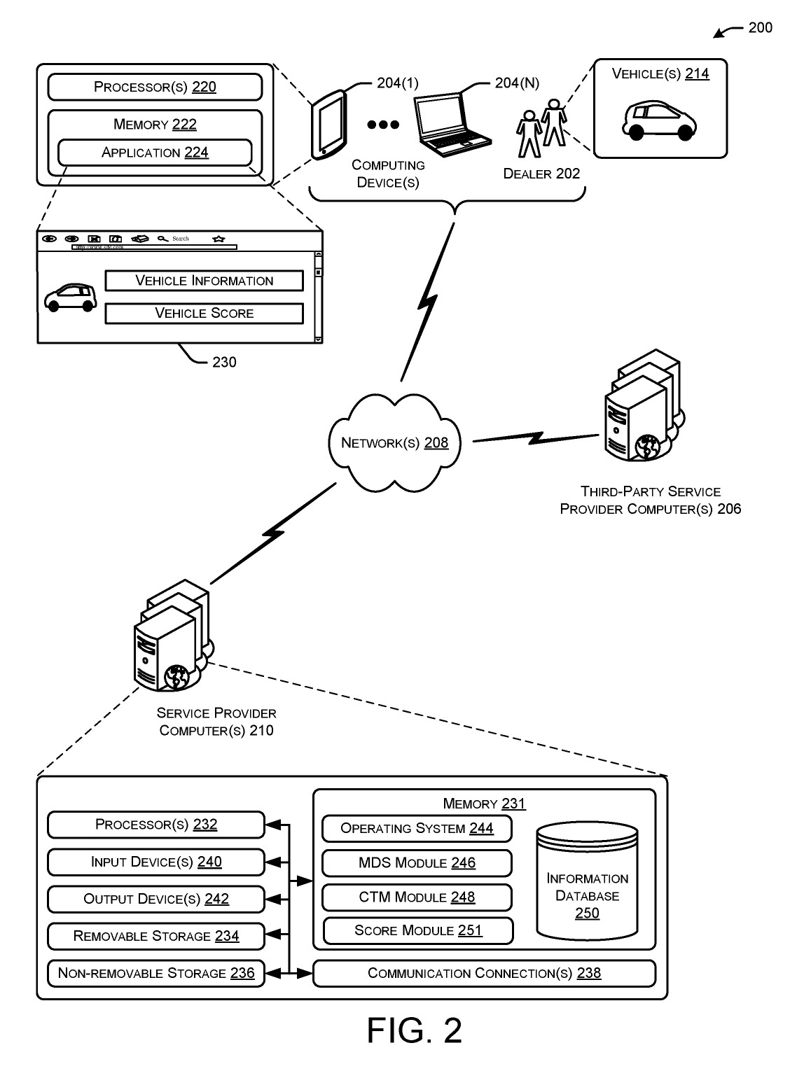

FIG. 2 depicts an illustrative system 200 for predictive modeling for evaluating vehicles, in accordance with one or more example embodiments of the present disclosure.

As shown in FIG. 2, the system 200 may include one or more service provider computers 210 (e.g., the one or more servers 104 of FIG. 1), one or more dealers 202 associated with one or more dealer devices 204(1), . . . , 204(N) (e.g., the device 102 of FIG. 1), and one or more third-party service provider computers 206. In the system 200, the dealers 202 may utilize the dealer devices 204 to access an application interface 230 (or website) that may be provided by, created by, or otherwise associated with the service provider computers 210 via one or more networks 208. The one or more dealer devices 204(1), . . . , 204(N) may call one or more active programming interfaces of the one or more service provider computers 210 using the application interface 230 to provide vehicle inputs and receive vehicle data and recommendations. In some instances, the dealer devices 204 may be configured to present or otherwise display the application interface 230 to the dealers 202. While the illustrated example represents the dealers 202 accessing the application interface 230 over the networks 208, the described techniques may equally apply in instances where the dealers 202 interact with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

In some aspects, the application interface 230 associated with the dealer devices 204 may allow the dealers 202 to access, receive from, transmit to, or otherwise interact with the service provider via the service provider computers 210. In some examples, the application interface 230 may also allow the dealers 202 to transmit to the service provider computers 210 over the networks 208 information associated with one or more vehicles 214. In addition, the application interface 230 may also allow the dealers 202 to receive from the service provider computers 210 over the networks 208 a vehicle score and/or an inventory score for the vehicles 214.

The vehicles 214 comprise potential vehicles that the dealer 202 is interested in purchasing for resale, or the vehicles 214 may be part of an inventory of the dealer 202. The vehicle information may include, but is not limited to, the make, the model, the year, the color, the mileage, the vehicle identification number (VIN), the condition, the trim, the vehicle history, and/or one or more features or options, etc. Further, in some examples, information about the vehicles 214 may be provided to the service provider computers 210 by third-party providers associated with the third-party service provider computers 206, such as, but not limited to, database management systems, other inventory management systems, other inventory data feeds, one or more vehicle identification number decoders, market databases, market value databases, or the like. The third-party service provider computers 206 may be associated with any number and/or type of third-party service providers that may provide a range of information and/or services that facilitate the determination of a vehicle score and/or an inventory score of the vehicles 214.

The service provider computers 210 may be any type of computing devices, such as, but not limited to, mobile, desktop, and/or cloud computing devices, such as servers. In some examples, the service provider computers 210 may be in communication with the dealer devices 204 and the third party service provider computers 206 via the networks 208, or via other network connections. The service provider computers 210 may include one or more servers, perhaps arranged in a cluster, as a server farm, or as individual servers not associated with one another. These servers may be configured to host a website viewable via the application interface 230 associated with the dealer devices 204 or any other Web browser accessible by a dealer 202. In addition, the service provider computers 210 may communicate with one or more applications or other programs running the dealer devices 204.

The dealer devices 204 may be any type of computing devices including, but not limited to, desktop personal computers (PCs), laptop PCs, mobile phones, smartphones, personal digital assistants (PDAs), tablet PCs, game consoles, set-top boxes, wearable computers, e-readers, web-enabled TVs, cloud-enabled devices and work stations, and the like. In certain aspects, the dealer devices 204 may include touch screen capabilities, motion tracking capabilities, cameras, microphones, vision tracking, etc. In some instances, each dealer device 204 may be equipped with one or more processors 220 and memory 222 to store applications and data, such as an auction application 224 that may display the client application interface 230 and/or enable access to a website stored on the service provider computers 210, or elsewhere, such as a cloud computing network.

The third-party service provider computers 206 may also be any type of computing devices such as, but not limited to, mobile, desktop, and/or cloud computing devices, such as servers. In some examples, the third-party service provider computers 206 may be in communication with the service provider computers 210 and/or the dealer devices 204 via the networks 208, or via other network connections. The third-party service provider computers 206 may include one or more servers, perhaps arranged in a cluster, as a server farm, or as individual servers not associated with one another. These servers may be configured to provide information associated with the vehicles 214. In some aspects, the third-party services may include, but are not limited to, information aggregation services (e.g., services that determine market values for items based on aggregated information associated with those items), financial institutions, credit institutions, and the like. As such, when requested by the service provider computers 210, the third-party service provider computers 206 may provide information associated with the vehicles 214. In some examples, this information may include a Market Day's Supply and/or a Cost to Market associated with the vehicles 214, which may be utilized by the service provider computers 210 to determine a vehicle score or an inventory score for the vehicles 214, which may be presented to the dealers 202.

In one illustrative configuration, the service provider computer 210 may include at least a memory 231 and one or more processing units (or processors) 232. The processors 232 may be implemented as appropriate in hardware, software, firmware, or combinations thereof. Software or firmware implementations of the processors 232 may include computer-executable or machine-executable instructions written in any suitable programming language to perform the various functions described.

The memory 231 may store program instructions that are loadable and executable on the processors 232, as well as data generated during the execution of these programs. Depending on the configuration and type of service provider computer 210, the memory 231 may be volatile (such as random access memory (RAM)) and/or non-volatile (such as read-only memory (ROM), flash memory, etc.). The service provider computer 210 or server may also include additional removable storage 234 and/or non-removable storage 236 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 231 may include multiple different types of memory, such as static random access memory (SRAM), dynamic random access memory (DRAM), or ROM.

The memory 231, the removable storage 234, and the non-removable storage 236 are all examples of computer-readable storage media. For example, computer-readable storage media may include volatile and non-volatile, removable and non-removable media implemented in any method or technology for the storage of information such as computer-readable instructions, data structures, program modules, or other data. The memory 231, the removable storage 234, and the non-removable storage 236 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the desired information and which can be accessed by the service provider computer 210 or other computing devices. Combinations of the any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 210 may also contain communication connection(s) 238 that allow the service provider computer 210 to communicate with a stored database, another computing device or server, user terminals, and/or other devices on a network. The service provider computer 210 may also include input device(s) 240 such as a keyboard, a mouse, a pen, a voice input device, a touch input device, etc., and output device(s) 242, such as a display, speakers, printers, etc.

Turning to the contents of the memory 231 in more detail, the memory 231 may include an operating system 244 and one or more application programs or services for implementing the features disclosed herein, including a Market's Day Supply (MDS) module 246, a Cost to Market (CTM) module 248, and a vehicle/inventory score (score) module 251. In some instances, the MDS module 246, the CTM module 248, and score module 251 may receive, transmit, and/or store information in the database 250.

The dealer devices 204, the one or more third-party service provider computers 206, and the one or more service provider computers 210 may be configured to communicate via the one or more networks 208, wirelessly or wired. The one or more networks 208 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the one or more networks 208 may have any suitable communication range associated therewith and may include, for example, global networks (e.g., the Internet), metropolitan area networks (MANs), wide area networks (WANs), local area networks (LANs), or personal area networks (PANs). In addition, the one or more networks 208 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Various instructions, methods, and techniques described herein may be considered in the general context of computer-executable instructions, such as program modules, executed by one or more computers or other devices. Generally, program modules may include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architectures and computing devices shown in FIG. 2 are provided by way of example only. Numerous other operating environments, system architectures, and device configurations are possible. Accordingly, embodiments of the present disclosure should not be construed as being limited to any particular operating environment, system architecture, or device configuration.

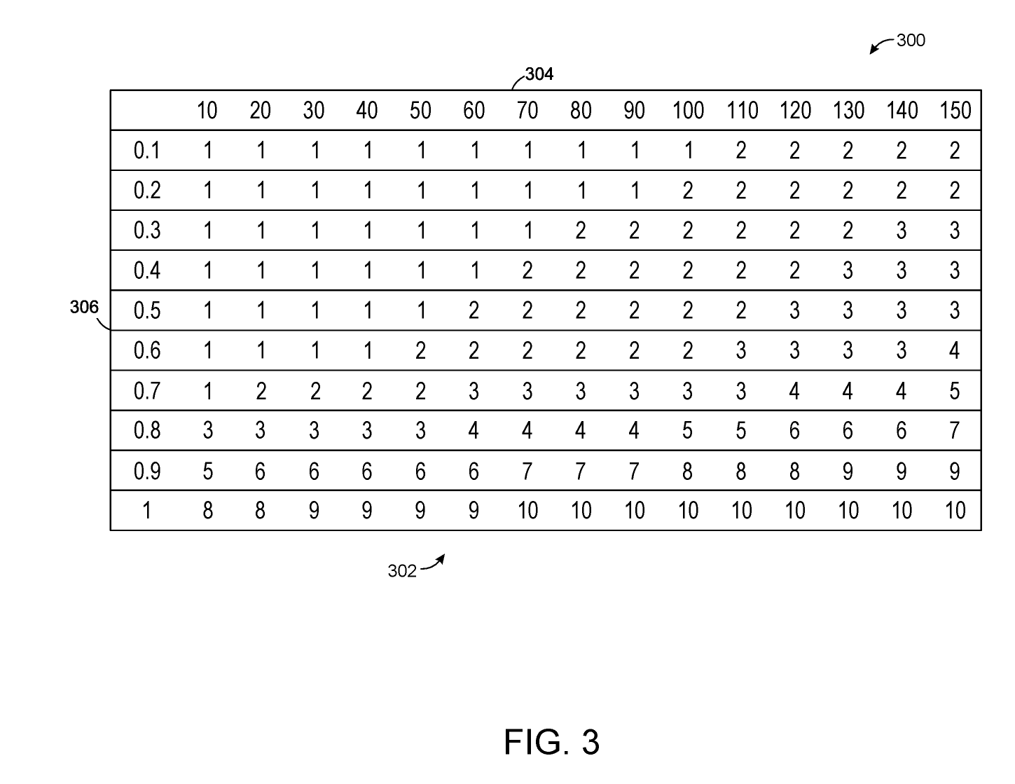

FIG. 3 depicts an exemplary vehicle score matrix 300, in accordance with one or more example embodiments of the present disclosure.

The vehicle score matrix as may be used to determine vehicle/inventory scores 302. The vehicle/inventory scores 302 may be derived from the vehicle score matrix 300. As depicted in FIG. 3, the vehicle score matrix 300 may include the Market Day's Supply 304 in the x-axis and the Cost to Market 306 in the y-axis. In FIG. 3, the Market Day's Supply 304 includes integers of 10. Any integer, fraction, or range may be used. The Market's Day Supply 304 for a particular vehicle may be rounded up or down to the nearest number. The Cost to Market 306 is shown in FIG. 3 as a percentage. That is, 0.1 equals 10% and so on. The Market Day's Supply 304 may be a score within a range (e.g., from 1-10), and the Cost to Market 306 may be a score within a range (e.g., from 1-10). The best inventory scores 302 may be for vehicles with a low Market Day's Supply 304 and a low Cost to Market 306.

The vehicle/inventory scores 302 may include a range from 1 to 10. Any range may be used. A score of 1 may indicate that a vehicle is likely to be profitable to the dealer based on the Market Day's Supply and the Cost to Market of the vehicle. In contrast, a higher score may indicate the vehicle is less likely to be profitable (and may even be a loss). In this manner, dealers prefer vehicle/inventory scores 302 that are closer to 1 than 10. In some instances, the vehicle/inventory scores 302 may be divided into multiple groups (e.g., platinum, gold, silver, bronze, or some other category indicating the value of the vehicles based on the vehicle/inventory scores 302). In the first group, for example, vehicle/inventory scores 302 ranging from 1-5 may indicate to the dealer that it should buy a vehicle in the first group or be patient with a first group vehicle on the lot (e.g., do not drop the price or offer significant incentives to purchase the vehicle). In this instance, the dealer may be shown a “Yes” indicator to convey to the dealer that the dealer should buy the vehicle or an indicator to convey that the dealer should not reduce the price of a vehicle. On the other hand, vehicle/inventory scores 302 ranging from 6-10 may indicate to the dealer that it should not buy a vehicle or should reduce the price of a vehicle on the lot. In this instance, the dealer may be shown a “No” indicator to convey to the dealer that the dealer should not buy the vehicle or an indicator that a vehicle's price may be lowered.

As depicted in FIG. 3, the Cost to Market 306 may be weighted more heavily than the Market Day's Supply 304 in determining the vehicle/inventory scores 302. How much weight is given to the Market Day's Supply 304 and the Cost to Market 306 may be updated in real time, daily, weekly, monthly, or yearly. More so, the weight that is given to the Market Day's Supply 304 and the Cost to Market 306 may vary between geographic locations, marketplaces, times of year, and/or types of vehicles.

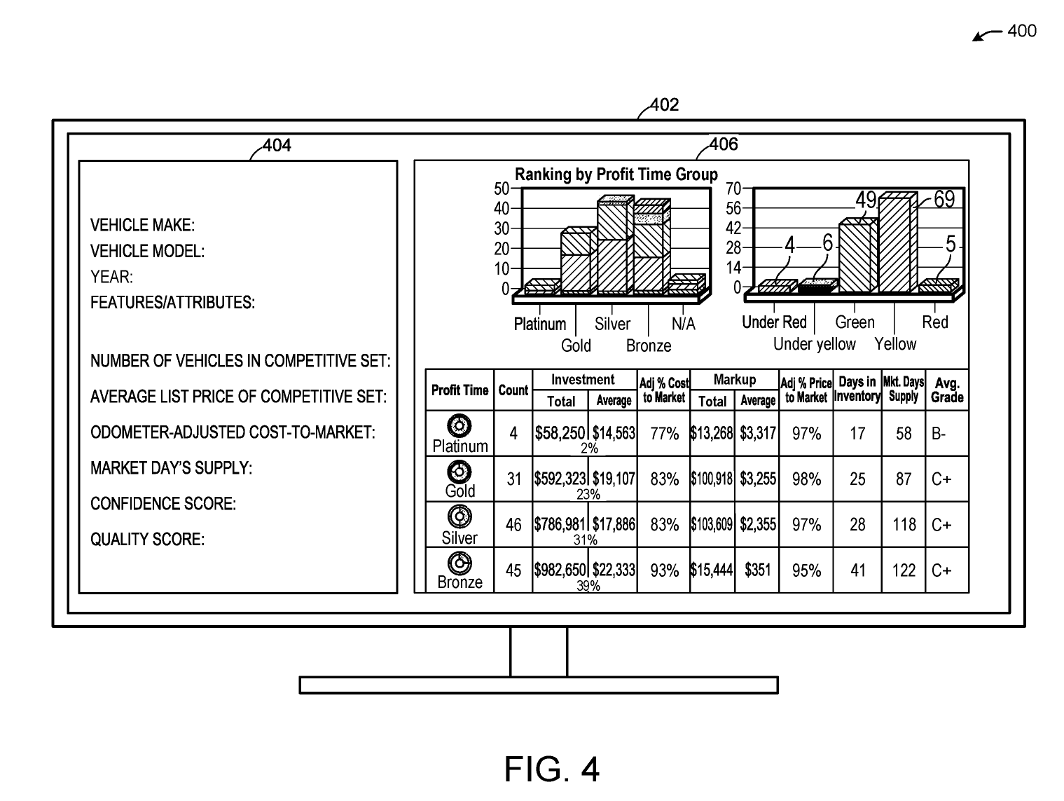

FIG. 4 illustrates an example graphical output 400, in accordance with one or more example embodiments of the present disclosure.

Referring to FIG. 4, the graphical output 400 may be provided by a device 402 (e.g., the device 102 of FIG. 1, the dealer devices 204 of FIG. 2). The graphical output 400 may include one or more windows (e.g., window 404, window 406) which may allow a user (e.g., dealer 202 of FIG. 2) to view vehicle information, scores, and recommendations (e.g., application interface 230 of FIG. 2).

In one or more embodiments, a window (e.g., window 404) may allow a user to make calls to one or more application program interfaces (e.g., application interface 230 of FIG. 2) to input vehicle data such a vehicle make, model, year, and features/attributes of a vehicle. The window 404 may receive competitive set data for similar vehicles in a geographic area. For example, the window 404 may display the number of vehicles in a competitive set, the average list price of vehicles in the competitive set, the odometer-adjusted Cost to Market of the vehicles in the competitive set, the Market's Day Supply of the vehicles in the competitive set, confidence scores of vehicles in the competitive set, and/or quality scores of vehicles in the competitive set.

In one or more embodiments, a window (e.g., window 406) may allow a user to see the vehicle data and recommendations received by the device 402 in response to vehicle inputs. The window 406 may display groups of vehicles based on respective vehicle scores (e.g., a platinum group, a gold group, a silver group, a bronze group, etc.), a grade or score of any vehicles or group of vehicles, the number of vehicles in a group, an adjusted Cost to Market of any vehicles, days in inventory (e.g., days on lot), a Market Day's Supply, and any recommendations (e.g., buy, sell, adjust price, maintain price, etc.).

In one or more embodiments, the window 404 and the window 406 may be displayed separately or concurrently. Concurrent display of the windows may allow a user to see any or all vehicles available or on a lot while also being able to adjust vehicle inputs used to determine the value of vehicles and to determine vehicle recommendations. The concurrent display may allow a user to see the value of a vehicle and associated vehicle recommendations while also seeing relevant information regarding the competitive set of vehicles used to determine the vehicle value and recommendations. Recommendations, rankings, prices, values, and other values and data may be provided graphically or in another format. A score or grade of a vehicle may indicate to a user to buy, sell, adjust price, maintain price, or take other action (or take no action) with regard to a vehicle or group of vehicles.

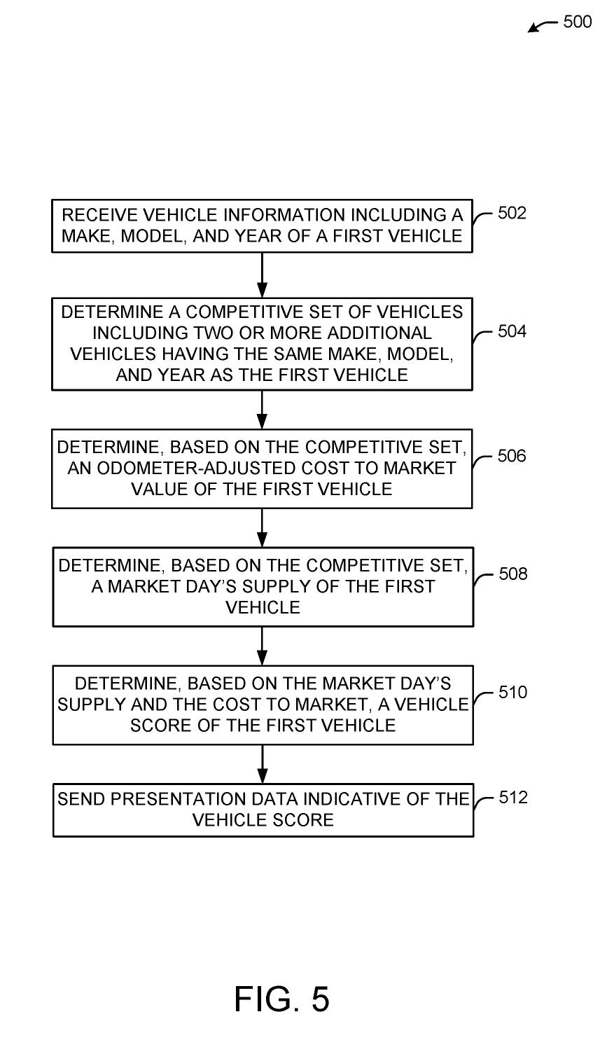

FIG. 5 illustrates an example flow diagram showing a process 500 for predictive modeling for evaluating vehicles, in accordance with one or more example embodiments of the present disclosure.

At block 502, a device (e.g., the one or more servers 104 of FIG. 1, the one or more service provider computers 210 of FIG. 2) may receive vehicle information from one or more devices (e.g., the device 102 of FIG. 1, the dealer devices 204 of FIG. 2). The vehicle information may be received using one or more application programming interfaces (e.g., the application interface 230 of FIG. 2) provided by the device. The vehicle information may include a vehicle make, model, and year, and may include additional features or description of a vehicle (e.g., two-door, four-door, trim, color, automatic transmission, manual transmission, number of engine cylinders, and other vehicle options). The vehicle information may represent a vehicle that a dealer is trying to sell, or may represent a vehicle that a dealer is considering purchasing.

At block 504, the device may determine a competitive set of vehicles based on the received vehicle information. The vehicles in the competitive set may include vehicles which are currently for sale and/or vehicles which were recently sold (e.g., within a threshold number of days). For example, when the received inputs of vehicle information provide a make, model, year, and features/description of a vehicle, the device may identify other similar vehicles with the same make, model, year, and features/description within a geographic area. For example, the device may access one or more computers (e.g., the one or more third-party service provider computers 206 of FIG. 2) to find matching vehicles. The device may call one or more application programming interfaces provided by the computers, and may input all or some of the vehicle information received. The device may receive similar vehicle data and store the data. The device may identify any similar vehicles matching the vehicle information when matching vehicles are stored on the device. Any vehicle may have an odometer reading at a given time, and the device may receive and store odometer readings for any vehicle. The device may identify a number of matching vehicles in a geographic area. If the number of matching vehicles does not exceed a threshold number of vehicles (e.g., to provide a sufficient sample size), the device may query the device which sent the vehicle information as inputs for different vehicle attributes/features, or may look for matching vehicles using a subset of the receive vehicle information inputs. Once a sample size of vehicles for a competitive set exceeds a threshold number of vehicles, the device may determine the average odometer reading of the competitive set of vehicles, and may determine a daily sale rate of the vehicles in the competitive sets over a period of time (e.g., a daily sale rate averaged during the course of a month or some other time period).

At block 506, the device may determine an odometer-adjusted Cost to Market of any vehicle in a competitive set. The device may normalize an average odometer reading for the vehicles in the competitive set by applying an odometer adjustment to the cost of any vehicle in the competitive set. The odometer adjustment may represent an amount of money per distance (e.g., cents per mile), and may be based on the make, model, year, and/or other vehicle attributes/description. For example, the odometer adjustment for a competitive set of one type of vehicles may be different than the odometer adjustment for a competitive set of another type of vehicles. The device may apply the odometer adjustment to the price of any vehicle in the competitive set. Using the odometer-adjusted prices of vehicles in the competitive set, the device may determine an odometer-adjusted Cost to Market of any vehicle by dividing the average odometer of the vehicles in the competitive set (e.g., adjusted for the odometer adjustment) by the average list price of the vehicles in the competitive set.

At block 508, the device may determine, based on the daily sale rate during a period of time, a Market Day's Supply of a vehicle in the competitive set. The device may determine a number of currently available vehicles (e.g., for sale) among the vehicles in the competitive set, and may divide the number of currently available vehicles by the daily sale rate of the vehicles in the competitive set during the time period. For example, if the time period is 45 days, the device may determine the daily sale rate of the vehicles in the competitive set over 45 days. The device may divide the currently available vehicles of the competitive set by the daily sale rate. For example, if ten vehicles in a competitive set are available, and the daily sale rate of the sold vehicles in the competitive set is five, then the Market Day's Supply of the vehicles in the competitive set may be two (e.g., 10/5=2). The device may determine a confidence score in the market pricing of vehicles in the competitive set. The confidence score may represent a standard deviation of the prices of the vehicles in the competitive set as a percentage of the average list price of the vehicles in the competitive set. For example, the device may take the list price of any vehicle in the competitive set divided by the average list price of the vehicles in the competitive set, and the result may be a confidence score for the price of the respective vehicle.

At block 510, the device may determine a vehicle quality score for any vehicle based on the Market Day's Supply and the odometer-adjusted Cost to Market of the respective vehicle. The device may determine a matrix or table of the Market Day's Supply and the odometer-adjusted Cost to Market of the vehicles in the competitive set. In one embodiment, the vehicle score matrix may include the Market Day's Supply in the x-axis and the Cost to Market in the y-axis. A lower Cost to market and a lower odometer-adjusted Cost to Market may result in a better vehicle score (or ranking). For example, a vehicle with a Market Day's Supply of one (e.g., a ratio of one available vehicle to one vehicle sold per day) and an odometer-adjusted Cost to Market of one (e.g., a vehicle with 10K miles and a list price of $10,000) may have a better quality score than a vehicle with a Market Day's Supply of ten (e.g., a ratio of ten available vehicles to one vehicle sold per day) and with an odometer-adjusted Cost to Market of ten (e.g., a vehicle with 100K miles and a list price of $10,000) because the first vehicle may be more likely to sell at a higher price than the second vehicle. Cheaper vehicles may need to have lower odometer-adjusted Costs to Market compared to more expensive cars, for example. The device may adjust the quality score up or down based on the confidence score (e.g., the quality score may be improved when the confidence score indicates that a vehicle's price is within a threshold amount of the average list price of vehicles in a competitive set including the vehicle). The score may come from a range of values (e.g., 1-11), with 1 being the best or worst score. If the daily sale rate of a vehicle is greater than one or another threshold value, the device may add or decrement the quality score of the vehicle to improve the score.

At block 512, the device may send presentation data indicative of the vehicle score to the one or more devices which sent the vehicle information inputs, or to other devices. The device may group vehicles according to their vehicle scores. For example, the device may set threshold vehicle score values for the best vehicle scores (e.g., platinum vehicles), the worst vehicle scores, and any categories in between (e.g., platinum, gold, silver, bronze, etc.). The device may generate and send graphical and/or textual data configured to be displayed by one or more devices (e.g., as shown in FIG. 4). The data may be configured to display in one or more windows which may be displayed concurrently to allow a user to see vehicle information inputs, related competitive vehicle set data for matching vehicles, vehicles the user owns, vehicles the user is considering buying, the categories and scores of vehicles, and vehicle recommendations. Based on the vehicle score, the device may send recommendations to be presented at other devices. The recommendations may indicate, based on the category and/or vehicle score of a vehicle, whether to adjust the vehicle's price and how, whether to buy a vehicle, whether to sell a vehicle, whether to maintain a vehicle's price, and other recommendations to allow a vehicle dealer to make decisions with regard to vehicle inventory management. The recommendations may provide real-time values of vehicles based on information which a user may not be able to aggregate manually in the time needed to make a decision regarding whether to adjust a vehicle price (e.g., in a vehicle price negotiation) or to buy a vehicle. The concurrent display of recommendations, scores, and vehicles owned by a dealer may allow a dealer to update vehicle inventory and inputs and see corresponding vehicle recommendations without having to open and close application windows.

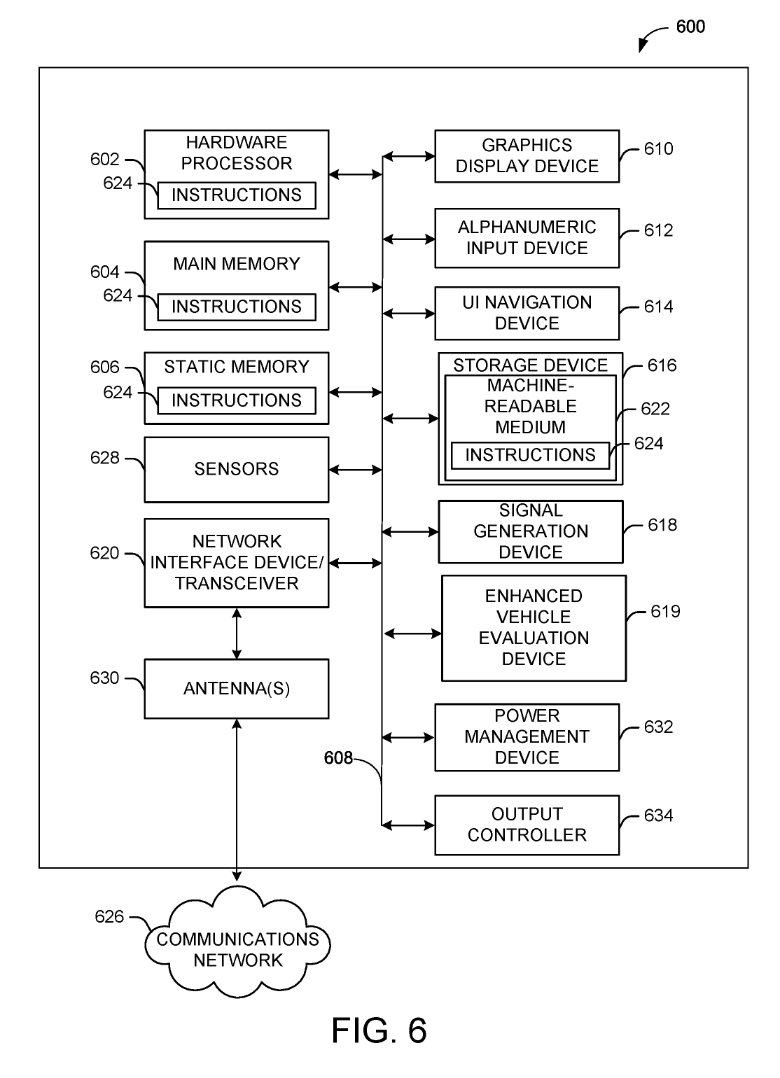

FIG. 6 illustrates a block diagram of an example of a machine 600 (e.g., the one or more servers 104 of FIG. 1, the one or more service provider computers 210 of FIG. 2) or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in Wi-Fi direct, peer-to-peer (P2P) (or other distributed) network environments. The machine 600 may be a server, a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., an emitter, a speaker), an enhanced vehicle evaluation device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The enhanced vehicle evaluation device 619 may carry out or perform any of the operations and processes (e.g., process 500 of FIG. 5) described and shown above.

In one or more embodiments, the enhanced vehicle evaluation device 619 may determine the vehicle score by using a vehicle score algorithm or matrix. The vehicle score matrix may include the Market Day's Supply in the x-axis and the Cost to Market in the y-axis. The lower the Market Day's Supply and the Cost to Market, the better the vehicle score, for example. A good vehicle score means the vehicle is likely to be profitable to the dealer. In contrast, the higher the Market Day's Supply and the Cost to Market, the worse the vehicle score, for example. A bad vehicle score may translate to less profitability (e.g., possibly even a net loss). The vehicle score may be updated in real time, daily, weekly, or monthly. That is, the vehicle score in the matrix may be revised based on actual market conditions or other factors or algorithms.

In one or more embodiments, the enhanced vehicle evaluation device 619 may determine the value of a vehicle based on grouping similar vehicles into a competitive set of vehicles. A competitive set may refer to vehicles with the same make, model, year, and features (e.g., colors, sunroofs, extended cabs, four-wheel drive, number of engine cylinders, etc.). The enhanced vehicle evaluation device 619 may aggregate vehicle data for similar vehicles in a given geographic area (e.g., a threshold radius/distance from the vehicle seller's location) and may generate a competitive set of vehicles for any particular make, model, and year vehicle. The enhanced vehicle evaluation device 619 may query one or more databases for nearby vehicle data by inputting the make, model, year, and any features of a vehicle, and if the number of results (e.g., similar vehicles) found in a geographic area fails to meet a threshold number of vehicles, the enhanced vehicle evaluation device 619 may add or remove vehicle features automatically or based on user inputs in order to generate a number of search results which exceeds a threshold value (e.g., a threshold may require that at least fifty similar vehicles in an area are included in a competitive set). The vehicle data in the databases used to provide query results to form the competitive set may be collected in real-time from one or more data providers, so the ability of the enhanced vehicle evaluation device 619 to determine a real-time competitive set for any make, model, and year vehicle in a geographic area may depend in another computer's ability to collect real-time data.

In one or more embodiments, the enhanced vehicle evaluation device 619 may determine the average list price and average odometer reading from the competitive set. For example, a vehicle with lower mileage may sell for a higher price than a vehicle with higher mileage. Odometer data of vehicles in the competitive set may indicate the mileage of each vehicle. When the enhanced vehicle evaluation device 619 identifies similar vehicles to use in the competitive set, the enhanced vehicle evaluation device 619 may receive data associated with the vehicles in addition to vehicle make, model, year, and location. The additional data may include vehicle odometer readings and current list prices. The enhanced vehicle evaluation device 619 may determine the average list price of the vehicles in the competitive set, and may determine the average odometer reading of the vehicles in the competitive set.

In one or more embodiments, the enhanced vehicle evaluation device 619 may apply an odometer adjustment to the cost of the vehicles in a competitive set in order to normalize the average odometer reading of the competitive set. The odometer adjustment may refer to a price per mile adjustment (e.g., cents per mile), and the price per mile adjustment may vary based on the make, year, model, location, and/or other attributes of the vehicles in a competitive set. For example, a convertible sports car may have a different odometer adjustment than a minivan, and a newer version of a particular make and model vehicle may have a different odometer adjustment than an older version of the same vehicle. Therefore, the attributes used to query databases for similar vehicles to form a competitive set may affect the odometer adjustment applied to the competitive, so the ability of the enhanced vehicle evaluation device 619 to determine a competitive set of vehicles with common attributes may be important to the ability of the enhanced vehicle evaluation device 619 to determine the value of a vehicle at a given time.

In one or more embodiments, the enhanced vehicle evaluation device 619 may determine an odometer-adjusted Cost to Market for the vehicles in the competitive set. For example, the enhanced vehicle evaluation device 619 may divide the odometer-adjusted cost of the vehicles in a competitive set by the average list price of the vehicles in the competitive set. The enhanced vehicle evaluation device 619 may determine the odometer-adjusted Cost to Market for any vehicle in a competitive set by determining the average odometer reading of the vehicles in the competitive set by the average list price of the vehicles in the competitive set, and applying the value to any vehicle to determine a vehicle's respective odometer-adjusted Cost to Market value.

In one or more embodiments, the enhanced vehicle evaluation device 619 may determine a Market Day's Supply for vehicles in a competitive set. Using the returned vehicles in the competitive set, the enhanced vehicle evaluation device 619 may count the number of currently available vehicles in the market and divide the number of currently available vehicles by a daily sale rate of similar cars (e.g., same make, model, year, etc.) over an interval of time (e.g., 45 days) to determine the Market Day's Supply for a vehicle. The interval of time may be set to a value long enough to account for significant daily sale changes (e.g., day with an unusually high number of sales of the type of vehicle in a competitive set). For example, if many vehicles in a competitive set sell on a particular day, the Market Day's Supply may be affected by a high daily sale rate. If the next day were a normal sale day (e.g., with lower sales of vehicles from the competitive set than the high-selling day), the Market Day's Supply would not necessarily fluctuate a significant amount, leading to a significant fluctuation in vehicle value from day-to-day. The interval of time may account for such fluctuations by considering the daily sale rate of vehicles in the competitive set over multiple days or weeks.

In one or more embodiments, the enhanced vehicle evaluation device 619 may determine the Market Day's Supply by dividing the current market quantity of a used vehicle of the same or similar year, make, model, trim level, etc., by the average daily retail sales rate over a period of time (e.g., the past 45 days). For example, if there are 10 identical or similarly equipped used vehicles for sale in the market and over the past 45 days they have been selling at 1 per day retail, then the Market Day's Supply is determined by dividing 10 by 1 to derive a 10 Market Day's Supply of that vehicle. The Market Day's Supply may indicate the demand of a vehicle on a given day. A higher Market Day's Supply may be indicative of a vehicle taking longer time to sell than a vehicle with a smaller Market Day's Supply.

In one or more embodiments, the enhanced vehicle evaluation device 619 may determine a confidence score for any vehicle in a competitive set of vehicles. The enhanced vehicle evaluation device 619 may determine a standard deviation of the prices of the vehicles in the competitive set as a percentage of the average list price of the vehicles in the competitive set. A vehicle's confidence score may be the vehicle's standard deviation of the average list price of the vehicles in the competitive set. The confidence score of a vehicle may refer to a statistical confidence in the market price of the vehicle. For example, the confidence score may represent the standard deviation of the price of the vehicle from the average vehicle price among the vehicles in the competitive set as a percentage of the average vehicle price of the vehicles in the competitive set. The confidence score for a competitive set if the standard deviation of the prices of the vehicles in the competitive set is lower.

In one or more embodiments, the enhanced vehicle evaluation device 619 may determine a quality score for any vehicle in a competitive set. Cheaper vehicles may need a lower Cost to Market score compared to a more expensive vehicle, for example, as a higher Cost to Market for a vehicle with a lower price may result in a lower profit margin. A more expensive vehicle may make a higher profit for a seller even with a higher Cost to Market. Therefore, the enhanced vehicle evaluation device 619 may assign a score within a score range (e.g., from 1 to 11) based on the Cost to Market and the Market Day's Supply for any vehicle. The enhanced vehicle evaluation device 619 may adjust the quality score to account for the confidence score of a vehicle. A higher confidence score may cause the enhanced vehicle evaluation device 619 to determine a higher quality score, and a lower confidence score may cause the enhanced vehicle evaluation device 619 to determine a lower quality score. The enhanced vehicle evaluation device 619 may assign a higher quality score to a vehicle based on the Cost to Market and the Market Day's Supply. For example, a vehicle with a lower Market Day's supply (e.g., a fast-selling vehicle) and a lower Cost to Market may receive a higher quality score because the vehicle may sell quickly at a higher profit margin than a vehicle which may take more time to sell at a lower profit margin. If a daily sale rate of a vehicle is greater than 1 or another threshold value, the enhanced vehicle evaluation device 619 may increase the quality score (e.g., may increment the quality score by 1 or another value).

In one or more embodiments, the enhanced vehicle evaluation device 619 may use the quality score of a vehicle to make recommendations to a user. For example, a high quality score may represent a strong investment, and the enhanced vehicle evaluation device 619 may recommend that vehicle sellers wait to sell vehicles which are strong investments. A lower quality score may represent a poor investment, and the enhanced vehicle evaluation device 619 may recommend that a vehicle seller price vehicles which are poor investments at lower prices to sell the lower-quality investment vehicles more quickly. The enhanced vehicle evaluation device 619 may rank competitive sets of vehicles based on their quality scores. Vehicles and their respective quality scores may be presented using one or more graphical user interfaces. The enhanced vehicle evaluation device 619 may use the one or more graphical user interfaces to display vehicle data, including the makes, models, and years of vehicles and any of vehicle features/attributes, and the enhanced vehicle evaluation device 619 may output recommendations such as to increase or decrease price, hold onto a vehicle, move a vehicle quickly, etc. The real-time nature of the outputs of the enhanced vehicle evaluation device 619 may provide vehicle sellers with updated data to make quick, informed decisions regarding whether to change vehicle prices, negotiate vehicle prices, buy, or sell vehicles. The enhanced vehicle evaluation device 619 may overlay recommendations with any vehicle information to allow a user to view whether a vehicle is priced competitively or should be adjusted in price while also presenting useful information regarding other vehicles in inventory and/or in a geographic area.

In one or more embodiments, the enhanced vehicle evaluation device 619 may determine the Cost to Market by dividing the cost of the used vehicle by the average list price of the same or similar vehicles. For example, the Cost to Market may measure the “spread” between the amount a dealer pays to acquire and recondition a used vehicle and the average retail price for the same/similar vehicles available in a market.

It is understood that the above are only a subset of what the enhanced vehicle evaluation device 619 may be configured to perform and that other functions included throughout this disclosure may also be performed by the enhanced vehicle evaluation device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

It is understood that the above descriptions are for purposes of illustration and are not meant to be limiting.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed:

1. A method, comprising:
receiving, by one or more computers comprising one or more processors, vehicle information, wherein the vehicle information comprises a make of a first vehicle, a model of the first vehicle, and a year of the first vehicle;
determining, by the one or more computers, a competitive set of vehicles, wherein the competitive set of vehicles comprises a second vehicle and a third vehicle, wherein the second vehicle and the third vehicle are of the same make, model, and year as the first vehicle, and wherein the competitive set of vehicles is associated with an odometer reading and a daily sale rate during a period of time;
determining, by the one or more computers, based on the odometer reading, an odometer-adjusted Cost to Market associated with the first vehicle;
determining, by the one or more computers, based on the daily sale rate during the period of time, a Market Day's Supply of the first vehicle;
determining, by the one or more computers, based on the Market Day's Supply and the odometer-adjusted Cost to Market, a vehicle score of the first vehicle; and
sending, by the one or more computers, presentation data indicative of the vehicle score.

2. The method of claim 1, wherein the competitive set of vehicles is a first competitive set of vehicles, wherein determining the first competitive set of vehicles further comprises:
determining a second competitive set of vehicles comprising the first vehicle and the second vehicle;
determining that the second competitive set of vehicles fails to exceed a threshold number of vehicles;
determining an attribute associated with the first vehicle and the second vehicle;
identifying, based on the attribute, the third vehicle; and
determining the first competitive set of vehicles exceeds the threshold number of vehicles.

3. The method of claim 1, further comprising:
determining an average list price of the competitive set of vehicles; and
determining the odometer reading divided by the average list price, wherein determining the odometer-adjusted Cost to Market associated with the first vehicle is based on the odometer reading divided by the average list price.

4. The method of claim 1, further comprising:
determining a number of vehicles from among the competitive set of vehicles, wherein the number of vehicles are available for purchase; and
determining the number of vehicles divided by the daily sale rate, wherein determining the Market Day's Supply of the first vehicle is based on the number of vehicles divided by the daily sale rate.

5. The method of claim 1, further comprising:
determining a standard deviation of a price of the first vehicle compared to an average list price of the competitive set of vehicles; and
determining a confidence score associated with the first vehicle based on the standard deviation, wherein determining the vehicle score is further based on the confidence score.

6. The method of claim 1, further comprising generating, based on the Market Day's Supply and the Cost to Market, a vehicle score matrix, wherein the vehicle score matrix is indicative of respective vehicle scores associated with the competitive set of vehicles.

7. The method of claim 1, further comprising:
determining one or more vehicle recommendations based on the vehicle score; and
sending the one or more vehicle recommendations.

8. The method of claim 7, wherein the one or more vehicle recommendations are configured to be displayed concurrently with data indicative of the competitive set of vehicles.

9. The method of claim 1, wherein the vehicle score indicates whether to adjust a price of the first vehicle.

10. A non-transitory computer-readable medium storing computer-executable instructions which when executed by one or more processors of a first device result in performing operations comprising:
receiving vehicle information, wherein the vehicle information comprises a make of a first vehicle, a model of the first vehicle, and a year of the first vehicle;
determining a competitive set of vehicles, wherein the competitive set of vehicles comprises a second vehicle and a third vehicle, wherein the second vehicle and the third vehicle are of the same make, model, and year as the first vehicle, and wherein the competitive set of vehicles is associated with an odometer reading and a daily sale rate during a period of time;
determining, based on the odometer reading, an odometer-adjusted Cost to Market associated with the first vehicle;
determining, based on the daily sale rate during the period of time, a Market Day's Supply of the first vehicle;
determining, based on the Market Day's Supply and the odometer-adjusted Cost to Market, a vehicle score of the first vehicle; and
sending presentation data indicative of the vehicle score.

11. The non-transitory computer-readable medium of claim 10, wherein the competitive set of vehicles is a first competitive set of vehicles, wherein determining the first competitive set of vehicles further comprises:
determining a second competitive set of vehicles comprising the first vehicle and the second vehicle;
determining that the second competitive set of vehicles fails to exceed a threshold number of vehicles;
determining an attribute associated with the first vehicle and the second vehicle;
identifying, based on the attribute, the third vehicle; and
determining the first competitive set of vehicles exceeds the threshold number of vehicles.

12. The non-transitory computer-readable medium of claim 10, the operations further comprising:
determining an average list price of the competitive set of vehicles; and
determining the odometer reading divided by the average list price, wherein determining the odometer-adjusted Cost to Market associated with the first vehicle is based on the odometer reading divided by the average list price.

13. The non-transitory computer-readable medium of claim 10, the operations further comprising:
determining a number of vehicles from among the competitive set of vehicles, wherein the number of vehicles are available for purchase; and
determining the number of vehicles divided by the daily sale rate, wherein determining the Market Day's Supply of the first vehicle is based on the number of vehicles divided by the daily sale rate.

14. The non-transitory computer-readable medium of claim 10, the operations further comprising:
determining a standard deviation of a price of the first vehicle compared to an average list price of the competitive set of vehicles; and
determining a confidence score associated with the first vehicle based on the standard deviation, wherein determining the vehicle score is further based on the confidence score.

15. The non-transitory computer-readable medium of claim 10, the operations further comprising generating, based on the Market Day's Supply and the Cost to Market, a vehicle score matrix, wherein the vehicle score matrix is indicative of respective vehicle scores associated with the competitive set of vehicles.

16. The non-transitory computer-readable medium of claim 10, the operations further comprising:
determining one or more vehicle recommendations based on the vehicle score; and
sending the one or more vehicle recommendations.

17. The non-transitory computer-readable medium of claim 16, wherein the one or more vehicle recommendations are configured to be displayed concurrently with data indicative of the competitive set of vehicles.

18. The non-transitory computer-readable medium of claim 10, wherein the vehicle score indicates whether to adjust a price of the first vehicle.

19. A device comprising memory coupled to at least one processor, wherein the at least one processor is configured to:
receive vehicle information, wherein the vehicle information comprises a make of a first vehicle, a model of the first vehicle, and a year of the first vehicle;
determine a competitive set of vehicles, wherein the competitive set of vehicles comprises a second vehicle and a third vehicle, wherein the second vehicle and the third vehicle are of the same make, model, and year as the first vehicle, and wherein the competitive set of vehicles is associated with an odometer reading and a daily sale rate during a period of time;
determine, based on the odometer reading, an odometer-adjusted Cost to Market associated with the first vehicle;
determine, based on the daily sale rate during the period of time, a Market Day's Supply of the first vehicle;
determine, based on the Market Day's Supply and the odometer-adjusted Cost to Market, a vehicle score of the first vehicle; and
send presentation data indicative of the vehicle score.

20. The device of claim 19, wherein the competitive set of vehicles is a first competitive set of vehicles, wherein to determine the first competitive set of vehicles further comprises the at least one processor being further configured to:
determine a second competitive set of vehicles comprising the first vehicle and the second vehicle;
determine that the second competitive set of vehicles fails to exceed a threshold number of vehicles;
determine an attribute associated with the first vehicle and the second vehicle;
identify, based on the attribute, the third vehicle; and
determine the first competitive set of vehicles exceeds the threshold number of vehicles.
